(19) United States
(12) Patent Application Publication
(10) Pub. No.: US 2010/0258560 A1
(43) Pub. Date: Oct. 14, 2010

(54) Anti Siphon Ball

(76) Inventor: James Hilton Parnell, Florence, AL (US)

Correspondence Address: James Hilton Parnell, 310 Heatherton Road, Florence, AL, 35633, US

(21) Appl. No.: 12/484,178

(22) Filed: Jun. 13, 2009

Related U.S. Application Data
(60) Provisional application No. 61/061,117, filed on Jun. 13, 2008.

(51) Int. Cl. B60K 15/04

(52) U.S. Cl. 220/86.3

(57) ABSTRACT

An anti siphon device constructed of polyethylene balls and placed within a fuel filling neck, above the fuel tank. The anti-siphon device is comprised of an outer perforated ball with an inner axis mounted ball on the interior. The device will allow the free flow of fuel while blocking siphon mechanisms to pass through and reaching the fuel stored below. The device is inexpensive to manufacture and install and does not negatively affect the vehicle operation or fuel refilling capacities.

### PREVIOUS FILING

This application emanates from a previous provisional patent filing; application No. 61/061,117 filed on Jun. 12, 2008

### FIELD OF THE INVENTION

The present invention generally relates to anti-siphon fuel filler systems. More particularly, the invention relates to an anti-siphon fuel filler assembly having restriction means for preventing unauthorized fuel removal and means for preventing the premature deactivation of automatic fuel dispensing systems caused by reverse fuel flow.

### BACKGROUND OF THE INVENTION

The increasing cost of petroleum products has created a corresponding increase in fuel theft. Fuel theft is especially widespread in the automotive industry. To remove fuel from a car or other vehicle, a siphon hose is commonly inserted through the filler neck tube into the fuel tank. The application of suction through the hose permits the withdrawal of fuel.

Various devices have been created which prevent access to the interior of the fuel tank. Many such devices use lock mechanisms. However, these devices are easily opened and generally ineffective. Furthermore, most require the use of a key. Loss of the key presents significant problems, especially if the vehicle operator has a delivery or travel deadline. Also, lock mechanisms frequently malfunction during cold and inclement weather. A need therefore exists for an improved anti-siphon system which prevents fuel theft in a simple and efficient manner, while avoiding the use of keys or lock mechanisms.

Large over-the-road trucks may carry hundreds of gallons of diesel fuel. If parked in an accessible location, a would-be thief need only insert a siphon tube into the fuel tank and create a vacuum to establish a flow from the tank to some other storage container. Thus, a length of flexible tubing and a container are virtually all the thief needs.

Because of the ease by which such fuel may be siphoned, it has been known to permanently mount an anti-siphon screen in the fill neck of such a fuel tank. Traditionally, the fill neck is simply welded to the fuel tank, and a portion of the fill neck extends within the tank's interior. The conventional anti-siphon screen surrounds a portion of the inner end of the fill neck (i.e., the end within the tank), and is suitably welded thereto. While effective, this required that the fill neck screen have been applied when the tank was originally manufactured. Existing tanks could not be retrofitted with an after-market fill neck screen. Moreover, should the fill neck screen become damaged for any reason, it could not be readily repaired.

Accordingly, there is believed to be a clear and present need for an improved anti-siphon device which can be quickly and removable mounted on a liquid storage tank.

It is a simple and inexpensive tool to keep gasoline thieves from stealing your gasoline.

### SUMMARY OF THE INVENTION

This invention (anti siphon ball) will make it virtually impossible to pass a siphon hose into a fuel tank. It will be cheap to manufacture and its use will be primarily aimed at newly manufactured automobiles, trucks and boats with built in gasoline tanks.

In accordance with the present invention, an anti-siphon ball device is provided. The inner and upper ends of the ball device have restriction means for preventing the insertion of siphon tubes or the like into the fuel tank. However, the restriction means is constructed to permit fuel flow therethrough. The filler neck ball device also has back pressure relief means including a plurality of openings, each opening having an pressure release capability. Any fuel prematurely flowing upward in the filler neck tube will exit through the openings, being outwardly deflected. This arrangement prevents the premature activation of pressure sensors in the fuel filler nozzle during filling of the tank. The filler neck tube ball device as described herein, may be used as an original equipment component in new motor vehicles. The invention may also be used as an insert in the filler neck tubes of existing motor vehicle fuel systems.

### BRIEF DESCRIPTION OF THE DRAWING

### DETAILED DESCRIPTION OF THE INVENTION

I claim:

1. An anti siphon ball device comprised of a polyethylene perforated hollow outer sphere which embodies a solid surface, axis mounted polyethylene inner sphere.

2. An anti siphon ball device of claim 1 wherein the device is larger in diameter than the entry and exit points of the automobiles fuel filling pipe.

3. An anti siphon ball device of claim 1 wherein the device is held in place within the automobile fuel filling pipe by an increase in the pipe size only in the area of installation.

4. An anti siphon ball device of claim 1 wherein the device can be constructed of any resin based material.

5. An anti siphon ball device of claim 1 wherein the inner ball can be solid or perforated.

6. An anti siphon ball device of claim 1 wherein the device is installed within and expanded diameter area of the gas filling pipe.
